(19) United States
(12) Patent Application Publication
(10) Pub. No.: US 2004/0099027 A1
(43) Pub. Date: May 27, 2004

(54) Manufacturing method for zeolite-containing fertilizer

(76) Inventor: Gary Rohwer, Parma, ID (US)

Correspondence Address: PEDERSEN & COMPANY, PLLC, P.O. BOX 2666, BOISE, ID, 83701, US

(21) Appl. No.: 10/287,946

(22) Filed: Nov. 4, 2002

Related U.S. Application Data
(60) Provisional application No. 60/337,886, filed on Nov. 2, 2001.

(51) Int. Cl. C05D 1/00

(52) U.S. Cl. 71/31

(57) ABSTRACT

This invention is a method for conveniently and economically manufacturing a zeolite-containing, slow-release fertilizer. For example, according to the method, crude zeolite ore is ground into particles. Crude waste precipitate from sugar beet refining, containing calcium carbonate, is also ground, screened, or shaken to a similar consistency. These components are then mixed in a roughly 2:1 weight ratio, zeolite:calcium carbonate, and preferably slurried with water. The water may be present in an amount, by weight, generally the same as the calcium carbonate component. After drying the mixed slurry, these mixed fertilizer precursor particles are processed for distribution using conventional means. When the precursor particles are applied to the field, they may be charged to become active, slow-release fertilizer by the addition of commercial agricultural fertilizers to the soil. Such commercial fertilizers may contain, for example, potassium and phosphorus. To prepare an application-ready fertilizer, commercial ammonium poly-phosphate solution (known in the industry as “10-34-0 solution”), or a similar substance, may also be mixed with the slurry at about 10 weight % of the zeolite. This way, the final mixture is ready as active fertilizer when applied to the field. An optional dust control agent may also be added to the zeolite: calcium carbonate mixture if desirable.

This application claims priority from, U.S. Provisional Patent Application Serial No. 60/337,886, filed on Nov. 2, 2001, entitled “Manufacturing Method for Zeolite-Containing Fertilizer” the disclosure of which is incorporated herein by this reference.

### BACKGROUND OF THE INVENTION

1. Field of the Invention

This invention relates generally to agriculture, and more specifically to fertilizers containing a zeolite component.

2. Related Art

U.S. Pat. No. 5,433,766 (Ming et al. '766) discloses a synthetic apatite-containing slow-release fertilizer. The apatite comprises crystalline calcium phosphate, micronutrients, and optionally, a carbonate.

U.S. Pat. No. 5,451,242 (Ming et al. '242) discloses a horticultural synthetic soil/fertilizer. The soil/fertilizer contains a zeolite saturated with a charge of potassium and nitrogen cations, in addition to the synthetic apatite of the Ming, et al. '766 patent, which is discussed above.

Still, there is a need for a rechargeable, slow-release fertilizer containing a zeolite. The present invention addresses this need.

### SUMMARY OF THE INVENTION

This invention is a method for conveniently and economically manufacturing a zeolite-containing slow-release fertilizer. In a preferred embodiment, the method of the invention utilizes readily-available raw materials, and handles them in conventional ways with conventional equipment.

For example, according to the method, crude zeolite ore is ground into small particles. The zeolite, preferably a clinoptilolite, may be washed to remove impurities and adjust pH. Also, according to the method, crude solid waste precipitate from sugar beet refining, containing calcium carbonate, is also ground, screened, or shaken to produce a particulate substance. Then, the zeolite component and the calcium carbonate component are mixed in a roughly 2:1 weight ratio (zeolite to calcium carbonate) and slurried with water. The water is added in approximately the same amount, by weight, as the calcium carbonate component. Optionally, a dust control agent such as, for example, SOILPAM™ type poly-acrylamide, available from Earth Chem, Inc., of Fort Collins, Colo., may be added to the slurry. After drying the mixed slurry, these mixed fertilizer precursor particles may be processed for distribution using conventional techniques.

When the precursor particles are applied to the field, they may be charged to become active, slow-release fertilizer by the addition of commercial agricultural fertilizers. Such commercial fertilizers may contain, for example, potassium and phosphorus.

To prepare an application-ready fertilizer, commercial ammonium phosphate solution (known in the industry as “10-34-0 solution”) is also mixed with the slurry at about 10 weight % of the zeolite. The addition of ammonium phosphate solution, or a similar substance, to the slurry charges the particles. Therefore, the final mixture may be applied to a field as an active fertilizer without additional supplementation.

### DETAILED DESCRIPTION OF THE INVENTION

For the zeolite-containing, slow-release fertilizer of the present invention:

1. The zeolite component is preferably a clinoptilolite zeolite mined in eastern Oregon, U.S.A. The crude clinoptilolite may be washed to remove impurities and adjust pH. The pH tends to increase slightly after washing. As received near Parma, Id., USA, the washed zeolite had about 2 weight % absorbed water in dry, summer conditions. The initial absorbed water content of the zeolite may vary due to the sourcing, transport, and local weather. An example of a preferred zeolite is CABSORB™, available from GSA Resources, Inc., of Cortaro, Ariz. Other zeolites may be used though none have yet been tested in accordance with this invention.

2. The calcium carbonate component is preferably the crude, solid waste precipitate from conventional sugar beet refining. This precipitate contains mostly calcium carbonate, although it typically contains other beneficial by-products of sugar beet refining as well. For example, the sugar beet refining precipitate typically contains, among others, nutrients like potassium, magnesium, sulfur, iron, and magnesium, and micronutrients like molybdenum, chlorine, boron, copper, zinc, and others. This waste precipitate known as “spent lime,” is available in large quantities near many sugar beet refineries, and should be economically available for many years.

Other calcium carbonate sources may also be used. Because an object of this invention is to provide an economical product, recycled calcium carbonate or any inexpensive source of calcium carbonate may be used. For example, “spent lime” from other industrial sources may be adequate.

Preferably, the zeolite component and the calcium carbonate component are mixed together in approximately a 2:1 weight ratio, respectively. However, this ratio may vary substantially due to the type, purity, and source of these raw materials. Ratios, for example, as high as 4:1 and as low as 1:1 are foreseeable, and should be effective.

Preferably, the zeolite component and the calcium carbonate component are mixed in the presence of water to form a slurry. The water component helps distribute and mix the zeolite and calcium carbonate components, and seems to also enhance the cation exchange capacity of the zeolite. If the calcium carbonate component comprises “spent lime” from sugar beet processing, the water is preferably present in generally the same amount, by weight, as the calcium carbonate component. Therefore, if a batch of fertilizer of the preferred composition calls for 4 tons of zeolite and 2 tons of spent lime, then about 2 tons of water will also be used. However, substantially more or less water may be used, depending, for example, on the type of processing equipment available.

Additionally, the water component helps distribute the optional dust control component—the poly-acrylamide—which is typically slightly hydrophobic. This way, the dust control component is well distributed in the final particle mix. A preferred dust control agent is SOILPAM™, available from EARTH CHEM, Inc., of Fort Collins, Colo. The dust control component may be used in conventional relative amounts, given the nature of the zeolite and calcium carbonate components.

After mixing, the zeolite/calcium carbonate/water slurry is allowed to dry. It may be dried at mild conditions (for example, ambient pressure; less than 250° F.) in a conventional rotary kiln or belt dryer. In warm, dry climates, the mixture may also be spread in shallow layers and exposed to the air for drying. This method may provide a further economic benefit to manufacturers of this fertilizer product.

The finished fertilizer precursor from the above manufacturing process may be used as a soil amendment. This way, after the zeolite-containing mixture is applied to the field, commercial fertilizers may be added to the soil which “charge” this soil amendment with potassium and phosphorus-containing cations. Then, in the soil, these cations may be “slow-released” due to the chemical equilibrium in the soil. When this “charged” soil amendment becomes “spent,” and the nutritionally important cations diminished, it may be “recharged” in like manner.

Also, an application-ready fertilizer may be produced with slight adjustments to the above process. In the slurry/mix step, commercial ammonium phosphate solution (a.k.a “10-34-0 solution”) may be added at about 10 weight % of the zeolite. This way, the final fertilizer particles already contain substantial phosphorus-containing cations, and are ready as an active fertilizer for field application.

Although this invention has been described above with reference to particular means, materials and embodiments, it is to be understood that the invention is not limited to these disclosed particulars, but extends instead to all equivalents within the scope of the following claims.

I claim:

1. A method of producing a rechargeable, slow-release agricultural fertilizer, comprising:
providing a particulate zeolite component;
providing a particulate calcium carbonate component;
mixing the particulate zeolite component with the particulate calcium carbonate component; and
processing of the resultant mixture for distribution.

2. The method according to claim 1, wherein:
said zeolite component and said calcium carbonate component are mixed in the presence of water to form a slurry.

3. The method according to claim 2, wherein the resultant mixed slurry is dried.

4. The method of claim 1, wherein the zeolite component is a clinoptilolite.

5. The method of claim 1, wherein the calcium carbonate component is spent lime.

6. The method of claim 1, wherein the zeolite and calcium carbonate are added to the mixture in generally about a 2 to 1 weight ratio, respectively.

7. The method of claim 2, wherein water is added to the mixture in generally about the same amount, by weight, as the calcium carbonate component.

8. The method of claims 1, wherein a commercial fertilizer containing, for example, phosphorous cations, may be added to the mixture prior to processing in an amount generally about 10 percent, by weight, of the zeolite component.

9. The method of claim 1, wherein a dust-control agent may be added to the particle mixture.
